(19) United States
(12) Patent Application Publication
(10) Pub. No.: US 2021/0123153 A1
(43) Pub. Date: Apr. 29, 2021

(54) Metal Three-Dimensional Printing without Sintering using Concurrent Particle Deposition and Electroplating

(71) Applicant: Naval Information Warfare Center, Pacific, San Diego, CA (US)

(72) Inventors: Paul D. Swanson, Lakeside, CA (US); Teresa H. Emery-Adleman, San Diego, CA (US)

(73) Assignee: United States of America as represented by Secretary of the Navy, San Diego, CA (US)

(21) Appl. No.: 16/665,504

(22) Filed: Oct. 28, 2019

(51) Int. Cl. C25D 17/00; C25D 5/10

(52) U.S. Cl. CPC C25D 17/007; B33Y 10/00; C25D 5/10

(57) ABSTRACT

A system is provided for use with a volume of metal particles suspended in electroplating solution. The system includes: a positional tip operable to have a positive electrical bias; a dispenser operable to dispense at least one of the metal particles and the electroplating solution; a metal base depositing system operable to deposit a metal base; a controller operable to control the positional tip to move and to control the dispenser to dispense the at least one of the metal particles and the electroplating solution; and a voltage controller operable to provide the positive electrical bias to the positional tip and to provide a negative electrical bias to the metal base so as to electroplate metal onto the metal base from the particles suspended in the electroplating solution and so as to three-dimensionally print a metal shape.

### FEDERALLY-SPONSORED RESEARCH AND DEVELOPMENT

The United States Government has ownership rights in this invention. Licensing inquiries may be directed to Office of Research and Technical Applications, Naval Information Warfare Center, Pacific, Code 72120, San Diego, Calif., 92152; telephone (619) 553-5118; email: ssc_pac_t2@navy.mil. Reference Navy Case No. 104015.

### BACKGROUND OF THE INVENTION

The present disclosure generally relates to three-dimensional printing of metal objects.

Three-dimensional (3D) printing of 3D structures using the binding of granular materials usually take one of two forms: 1) selective deposition of granular materials in a layered process with each consecutive layer be bound to the previous either by melting and cooling or by an intergranular adhesive; or 2) the consecutive burying of the printed structure with a thin plane of granular material and the selective melting or gluing of the new granular material to the previously solidified structure. For the conventional 3D printing of solid metals, adhesives are not an option; therefore each layer of added granular metal needs to be melted or “sintered” onto the previously sintered material.

There exists a need for a system and method for printing of metals with materials that cannot withstand the temperatures of sintering.

### SUMMARY OF THE INVENTION

An aspect of the present disclosure is drawn to a system for use with a volume of metal particles suspended in electroplating solution. The system includes a positional tip, a dispenser, a metal base depositing system, a controller and a voltage controller. The positional tip is operable to have a positive electrical bias. The dispenser is operable to dispense at least one of the metal particles and the electroplating solution. The metal base depositing system is operable to deposit a metal base. The controller is operable to control the positional tip to move and to control the dispenser to dispense the at least one of the metal particles and the electroplating solution. The voltage controller is operable to provide the positive electrical bias to the positional tip and to provide a negative electrical bias to the metal base so as to electroplate metal onto the metal base from the metal particles suspended in the electroplating solution and so as to three-dimensionally print a metal shape.

### BRIEF DESCRIPTION OF THE DRAWINGS

The accompanying drawings, which are incorporated in and form a part of the specification, illustrate example embodiments and, together with the description, serve to explain the principles of the disclosure. A brief summary of the drawings follows.

FIG. 1 illustrates an example 3D metal printing system in accordance with aspects of the present disclosure.

FIG. 2 illustrates an example method of 3D metal printing in accordance with aspects of the present disclosure.

FIG. 3 illustrates a positional tip and dispenser dispensing metal particles and an electroplating solution for 3D metal printing in accordance with aspects of the present disclosure.

FIG. 4A illustrates a side view of the positional tip and dispenser of FIG. 3 at a time t₁.

FIG. 4B illustrates a side view of the positional tip and dispenser of FIG. 3 at a time t₂.

FIG. 4C illustrates a side view of the positional tip and dispenser of FIG. 3 at a time t₃.

FIG. 4D illustrates a side view of a 3D object created by the method of FIG. 2.

FIG. 5 illustrates a side view of an alternative object being created by the positional tip and dispenser of FIG. 3 at a time t₄.

FIG. 6 illustrates a side view of the 3D object created in FIG. 5.

FIG. 7 illustrates another example method of 3D metal printing in accordance with aspects of the present disclosure.

FIG. 8A illustrates a side view of another positional tip and dispenser in accordance with aspects of the present disclosure at a time t₅.

FIG. 8B illustrates a side view of the positional tip and dispenser of FIG. 8A at a time t₆.

FIG. 8C illustrates a side view of the positional tip and dispenser of FIG. 8A at a time t₇.

FIG. 8D illustrates a side view of a 3D electroplated metal shape at a time t₈.

FIG. 8E illustrates a side view of a 3D object created by the method of FIG. 7.

FIG. 9 illustrates another example method of 3D metal printing in accordance with aspects of the present disclosure.

FIG. 10A illustrates a side view of another positional tip in accordance with aspects of the present disclosure at a time t₉.

FIG. 10B illustrates a side view of the positional tip of FIG. 10A at a time t₁₀.

FIG. 10C illustrates a side view of the positional tip of FIG. 10A at a time t₁₁.

FIG. 11 illustrates another positional tip and dispenser dispensing metal particles and an electroplating solution for 3D metal printing in accordance with aspects of the present disclosure.

### DETAILED DESCRIPTION OF THE EMBODIMENTS

The purpose of this present disclosure is to allow the 3D printing of solid metals without the need for laser or furnace sintering of the printed metal particles. This present disclosure substitutes electroplating between metal particles instead of sintering to create a solid metal structure.

There are two embodiments of the present disclosure: one where metal particles are printed and the other where the solid metal part being constructed is periodically buried in metal particles, with a thin planar layer of particles covering the last layer being solidified into place.

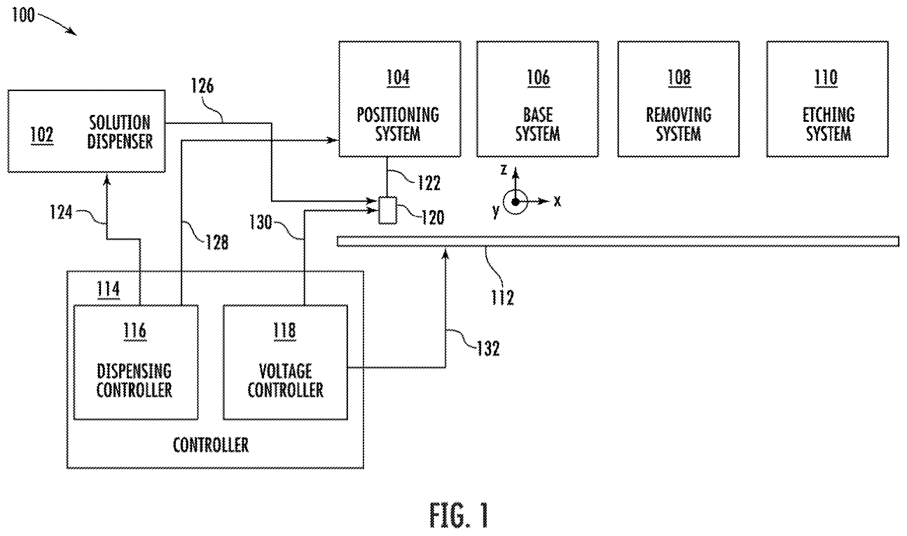

In the first embodiment, electroplating uses an ion current with a metal salt solution to deposit metal particles onto a surface of a negative electrode. Where the metal deposits is very much a function of the electric field lines (paths of ionic flow) between the positive and negative electrodes in the solution. If a dispensing tip is dispensing metal particles suspended in an electroplating solution onto a sacrificial (removable) electrode negatively biased (DC or pulsed) with respect to the conductive dispensing tip itself, electroplating will occur first between the sacrificial electrode and the first layer of metal particles, then between the metal connected to the negative sacrificial electrode and the metal particles between the connected particles and the dispensing tip. After the 3D object is finished, excess electroplating solution may be rinsed off and the sacrificial negative electrode may etched away. The first embodiment will now be described with reference to FIGS. 1-6.

FIG. 1 illustrates an example 3D metal printing system 100 in accordance with aspects of the present disclosure. As shown in the figure, 3D metal printing system 100 includes a solution dispenser 102, a positioning system 104, a base system 106, a removing system 108, an etching system 110, a printing platform 112, a controller 114 that includes a dispensing controller 116 and a voltage controller 118 and a positional tip and dispenser 120.

Solution dispenser 102 may be any known device or system that is operable to dispense at least one of metal particles and an electroplating solution. In one set of embodiments, solution dispenser 102 dispenses metal particles suspended in an electroplating solution through an arrangement of piping 126 to positional tip and dispenser 120, wherein arrangement of piping 126 is a single pipe. In another set of embodiments, solution dispenser 102 dispenses metal particles separately from the electroplating solution through arrangement of piping 126 to positional tip and dispenser 120, wherein arrangement of piping 126 includes separate pipes for each of the metal particles and the electroplating solution. Non-limiting examples of solution dispenser 102 includes holding tanks in combination with controllable valves, and holding tanks in combination with augers or hoppers.

Positioning system 104 may be any know system that is operable to move positional tip and dispenser 120 so as to controllably print a two-dimensional (2D) or 3D item. In some embodiments, positioning system 104 is able to move positional tip and dispenser 120 in two dimensions relative to printing platform 112, whereas in other embodiments, positioning system 104 is able to move positional tip and dispenser 120 in three dimensions relative to printing platform 112.

Base system 106 may be any known system that is operable to deposit a metal base onto printing platform 112 or onto a device that is to be electroplated. Non-limiting examples of base system 106 include a metal deposition system and an automated gripping and placing system that is able to place a premade metal object onto printing platform 112.

Removing system 108 may be any known system that is operable to remove excess metal particles and/or excess electroplating solution. Non-limiting examples of removing system 108 include a chemical rinsing system and a vacuum system.

Etching system 110 may be any known system that is operable to etch unwanted portions of a metal base.

Printing platform 112 may be any known platform that is operable to support a metal base and a 3D metal object to be printed.

Dispensing controller may be any device or system that is operable to control solution dispenser 102.

Voltage controller 118 may be any device or system that is operable to provide a positive electrical bias to positional tip and dispenser 120 and to provide a negative electrical bias to the metal base so as to electroplate metal onto the metal base from the metal particles suspended in the electroplating solution and so as to three-dimensionally print a metal shape.

Positional tip and dispenser 120 may be any device or system that is operable to have a positive electrical bias as provided by voltage controller 118, to move as controlled by positioning system 104 and to dispense at least one of metal particles and the electroplating solution as provided by solution dispenser 102 via piping 126.

In this example, dispensing controller 116 and voltage controller 118 are illustrated as individual devices. However, in some embodiments, dispensing controller 116 and voltage controller 118 may be combined as a unitary device. Further, in some embodiments, at least one of dispensing controller 116 and voltage controller 118 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to a processor such that the processor may read information from, and write information to the tangible computer-readable media. In the alternative, the tangible computer-readable media may be integral to the processor. The processor and the tangible computer-readable media may reside in an application specific integrated circuit (“ASIC”). In the alternative, the processor and the tangible computer-readable media may reside as discrete components.

Example tangible computer-readable media may be also be coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

Components of an example computer system/server may include, but are not limited to, one or more processors or processing units, a system memory, and a bus that couples various system components including the system memory to the processor.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

A program/utility, having at least one set of program modules, may be stored in the memory by way of example, and not limitation, as well as an operating system, one or more application programs, other program modules, and program data. Each of the operating system, one or more application programs, other program modules, and program data or some combination thereof, may include an implementation of a networking environment. The program modules generally carry out the functions and/or methodologies of various embodiments of the application as described herein.

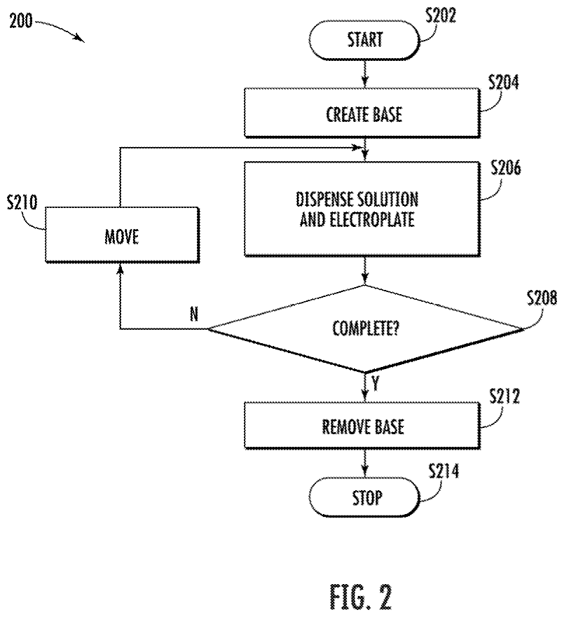

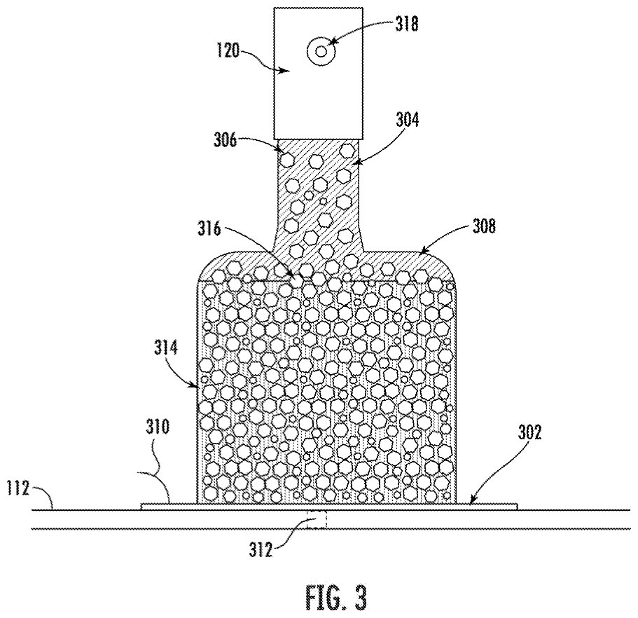

FIG. 2 illustrates an example method 200 of 3D metal printing in accordance with aspects of the present disclosure. As shown in the figure, method 200 starts (S202) and a metal base is created (S204). For example, as shown in FIG. 1, base system 106 may be any known device or system that is operable to create a conductive metal base onto printing platform 112. In an example embodiment, base system 106 is a deposition system that is operable to deposit a metal layer onto printing platform 112. It should be noted that in accordance with aspects of the present disclosure, a metal base may be disposed by base system 106 by placing a metal object, such as a metal rod or parallel piped, onto printing platform 112. A conductive metal base will be described in greater detail with reference to FIG. 3.

FIG. 3 illustrates positional tip and dispenser 120 dispensing metal particles suspended within an electroplating solution for 3D metal printing in accordance with aspects of the present disclosure.

As shown in the figure, a metal base 302 has been deposited onto printing platform 112. In this example, metal base 302 is a metal layer. As will be discussed later in more detail, the metal base may be made of any conducting metal that is easily deposited on printing platform 112 and that may be arranged to receive a negative electrical bias.

In this example embodiment, metal base 302 may have a conducting wire 312 attached thereto in any known manner, such as for example with alligator clips. Further, a conducting via 310 may provide a conduction path to metal base 302 through printing platform 112. In any known manner, metal base 302 is electrically connected to voltage controller 118 as shown in FIG. 1, via a voltage control line 132.

After the metal base is created (S204), a solution is dispensed and electroplating is performed (S206). For example, as shown in FIG. 1, dispensing controller 116 controls solution dispenser 102, via a control line 124, to dispense metal particles suspended in an electroplating solution through piping 126 to positional tip and dispenser 120. Dispensing controller 116 additionally controls, via a control line 128, positioning system 104 to position positional tip and dispenser 120 so as to initiate dispensing of the metal particles suspended in the electroplating solution onto printing platform 112 so as to deposit onto metal base 302.

As shown in FIG. 3, positional tip and dispenser 120 dispenses metal particles suspended in an electroplating solution 304, which includes metal particles 306 and electroplating solution 308, onto metal base 302.

As shown in FIG. 1, voltage controller 118 provides a positive voltage bias to positional tip and dispenser 120 via a voltage control line 130 and provides a negative voltage bias to metal base 302 (not shown in FIG. 1) via voltage control line 132. As shown in FIG. 3, the negative voltage bias is provided to metal base 302 by way of conducting wire 312, conducting via 310 or any other known mechanism. The potential difference between the positive voltage bias provided to positional tip and dispenser 120 and the negative voltage bias provided to metal base 302 results in an electrical conduction through electroplating solution 308 that results in the electroplating of the metal particles 306 onto metal base 302.

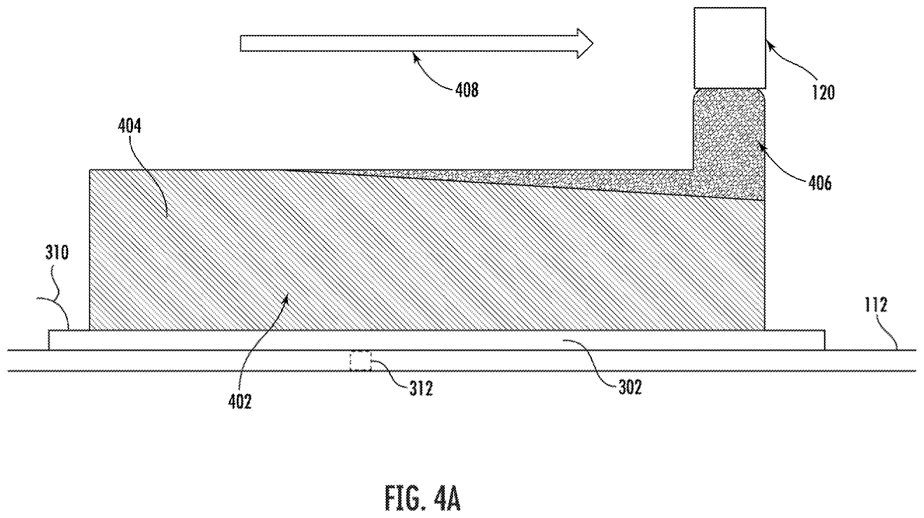

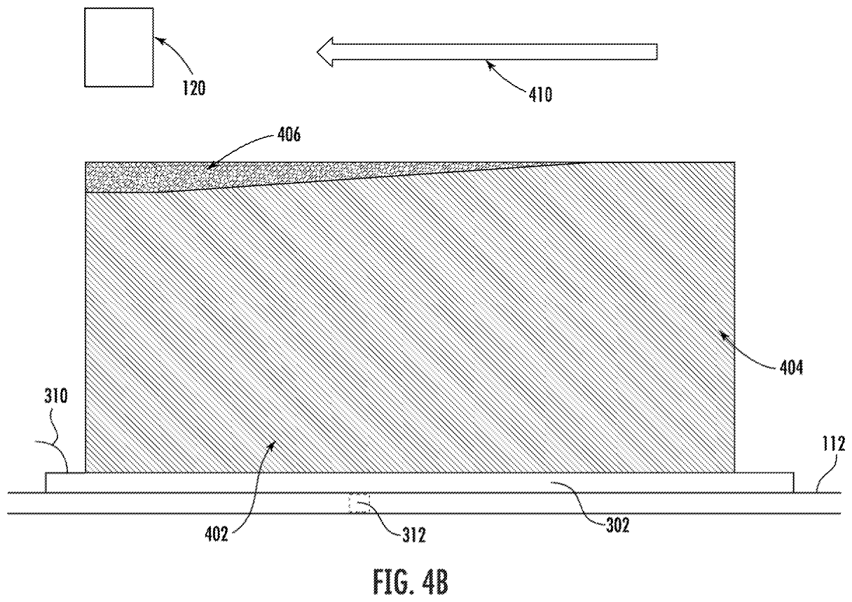

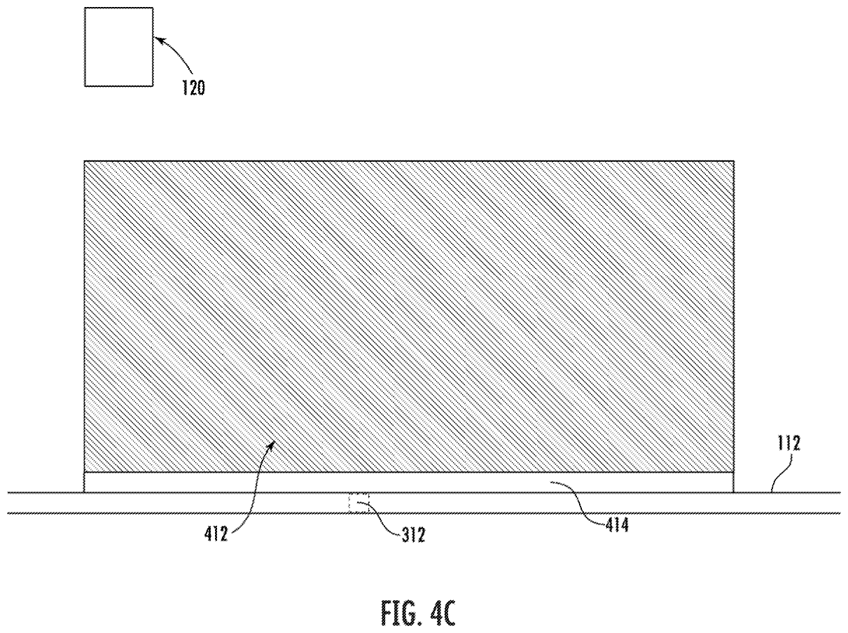

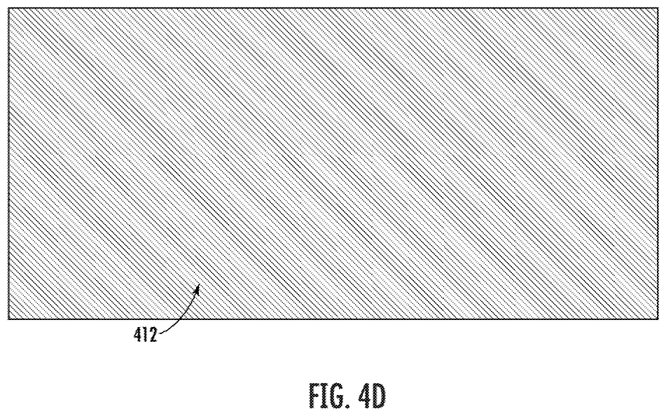

As shown by the circled dot 318, positional tip and dispenser 120 is moving in a direction into the figure by positioning system 104 (seen in FIG. 1) so as to dispense the metal particles suspended in the electroplating solution in a linear form. This will be described in more detail with reference to FIGS. 4A-B.

FIG. 4A illustrates a side view of positional tip and dispenser 120 of FIG. 3 at a time t₁. As shown in FIG. 4A, positional tip and dispenser 120 is moving in a direction as indicated by arrow 408 so as to dispense the metal particles suspended in the electroplating solution onto metal base 302 as a linear form 402. The metal particles are not immediately electroplated. As shown, the metal particles electroplate on top of one another from metal base 302 toward positional tip and dispenser 120. Because positional tip and dispenser 120 is moving in the direction of arrow 408, the electroplated metal is illustrated as area 404, whereas the metal particles that have not yet electroplated are shown as area 406.

After solution is dispensed and electroplating is performed (S206), it is determined whether electroplating is complete (S208). This determination may be performed by controller 114.

If electroplating is not complete (N at S208), then positional tip and dispenser 120 is moved (S210). For example, dispensing controller may instruct positioning system 104 to move positional tip and dispenser 120.

After the positional tip and dispenser 120 is moved (S210), more solution is dispensed and additional electroplating is performed (S206). This will be described in greater detail with reference to FIG. 4B.

FIG. 4B illustrates a side view of positional tip and dispenser 120 of FIG. 3 at a time t₂, which is after the time t₁ as illustrated in FIG. 4A. As shown in FIG. 4B, positional tip and dispenser 120 is moving in a direction as indicated by arrow 410 so as to dispense the metal particles suspended in the electroplating solution onto linear form 402 of FIG. 4A, so as to increase the height of the linear form 402. Again, as mentioned previously, the metal particles are not immediately electroplated. As shown, the metal particles electroplate on top of one another from the previous portion of linear form 402, as illustrated in FIG. 4A, toward positional tip and dispenser 120. Because positional tip and dispenser 120 is moving in the direction of arrow 410, the electroplated metal is illustrated as area 404, whereas the metal particles that have not yet electroplated are shown as area 406.

If electroplating is complete (Y at S208), portions of the metal base may be removed (S212).

FIG. 4C illustrates a side view of positional tip and dispenser 120 of FIG. 3 at a time t₃, which is after the time t₂ as illustrated in FIG. 4B. In FIG. 4C, electroplating is complete with an electroplated metal object 412 disposed on a metal base 414. In particular, in this figure, etching system 110 will have etched the portion of 302 that extends beyond the electroplated metal object 412 to create metal base 414.

After portions of the metal base are removed (S214) method 200 stops (S216).

FIG. 4D illustrates a side view of a 3D object 412 created by method 200 of FIG. 2. In this example, the entirety of metal base 414 as shown in FIG. 4C has been removed. However, in some embodiments, metal base 414 may remain as desired. As mentioned previously, system 100 and method 200 3D printed a metal object without sintering, thereby avoiding the temperatures and energy required for sintering.

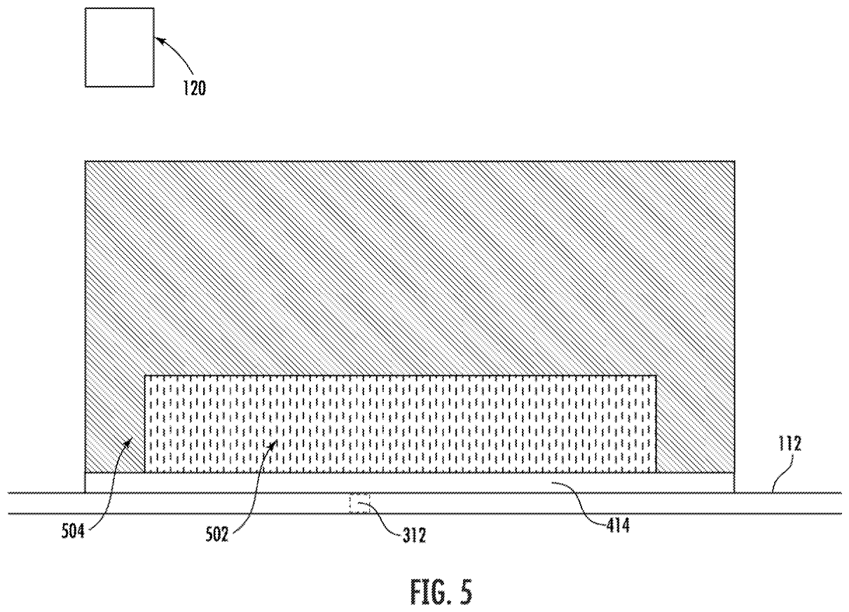

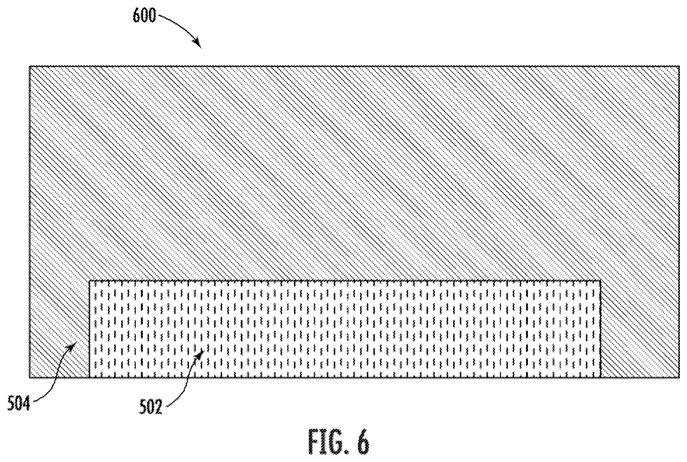

It should be noted that method 200 may additionally be used to 3D print metal onto another object, for example a non-metal object. This is shown in FIGS. 5-6.

FIG. 5 illustrates a side view of an alternative object being created by positional tip and dispenser 120 of FIG. 3 at a time t₄, which is similar to the time t₃ as illustrated in FIG. 4C. In FIG. 5, electroplating is complete with an electroplated metal object 504 disposed on a non-metal object 502 that is disposed on metal base 414. In particular, in this figure, etching system 110 will have etched the portion of metal base 302 that extends beyond the electroplated metal object 504 to create metal base 414.

FIG. 6 illustrates a side view of 3D object 600 created in FIG. 5. In this example, the entirety of metal base 414 as shown in FIG. 4C has been removed. However, in some embodiments, metal base 414 may remain as desired. In this example, system 100 and method 200 3D printed a metal object over a non-metal object without sintering, thereby avoiding the temperatures and energy required for sintering, and therefore without damaging non-metal object 502.

In the above discussed embodiments with reference to method 200, an electrolyte solution having metal particles suspended therein is deposited and electrolysis is performed. However, in other embodiments, the metal particles may be deposited first and the electrolyte solution may be deposited second.

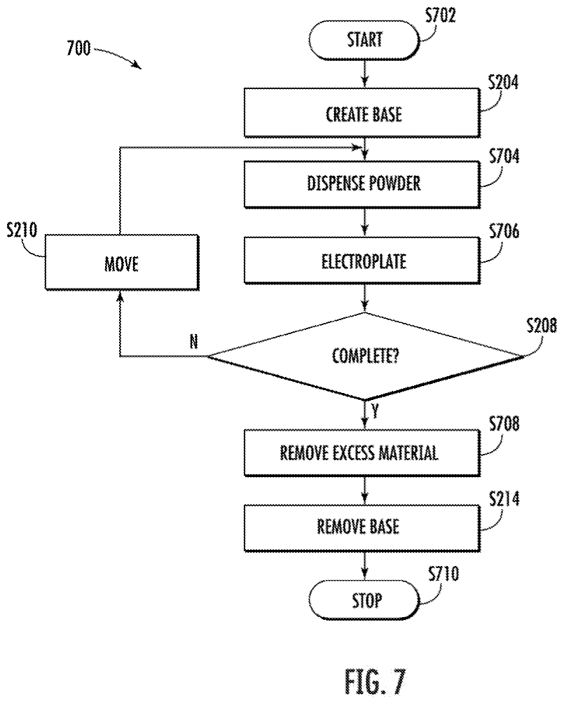

For example, in some embodiments, a planar layer of metal particles is added across the work area. Then an electroplating solution is dispensed into the metal particles to electroplate a horizontal slice of the object being printed. Then the addition of an additional layer of metal particles, the dispensing of the electroplating solution and the electroplating is repeated until the full 3D object has been realized. A sacrificial electrode, negatively biased with respect to the dispensing tip, would again be at the bottom of the printed shape. After the desired shape has been realized, the excess particles and plating solution would be washed away and the sacrificial electrode may be etched off. The second embodiment will now be described with reference to FIGS. 7-10C.

FIG. 7 illustrates another example method 700 of 3D metal printing in accordance with aspects of the present disclosure. As shown in the figure, method 700 starts (S702) and a metal base is created (S204) in a manner as discussed above with reference to method 200.

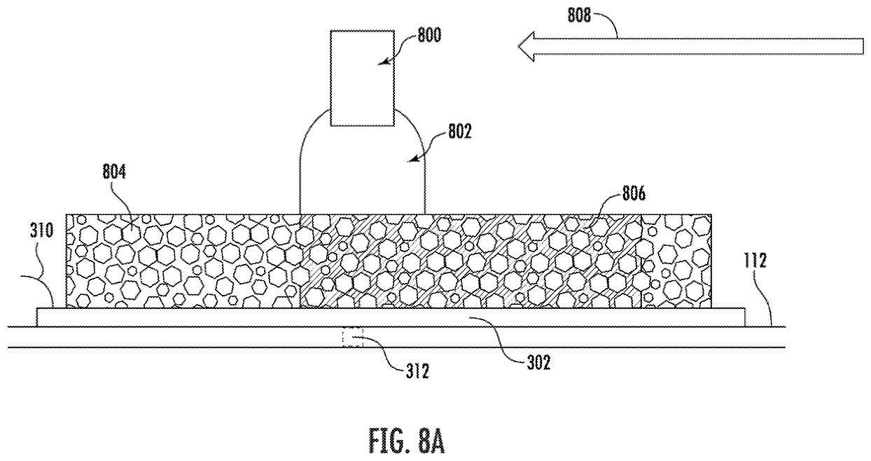

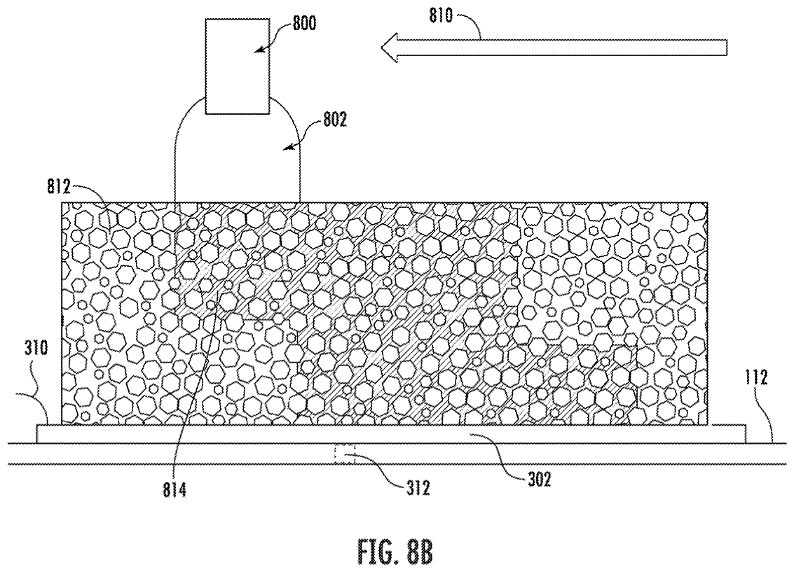

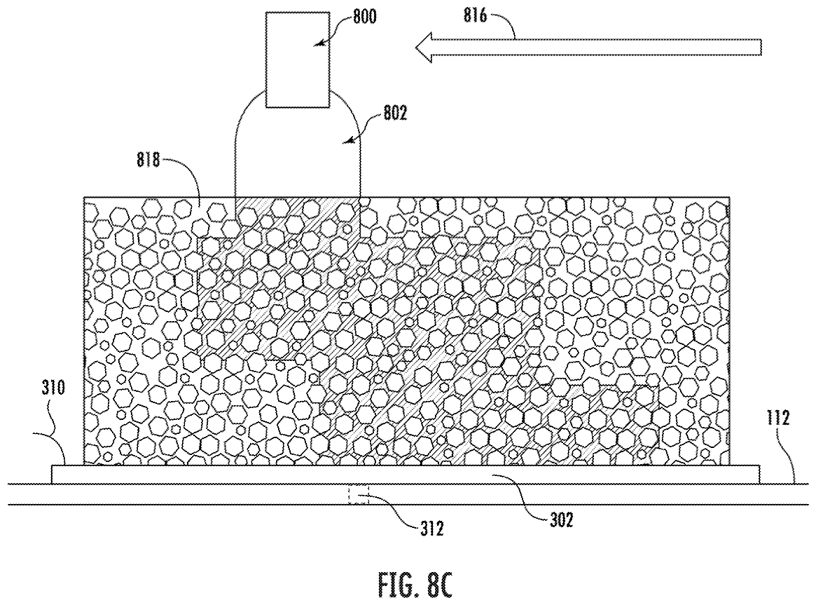

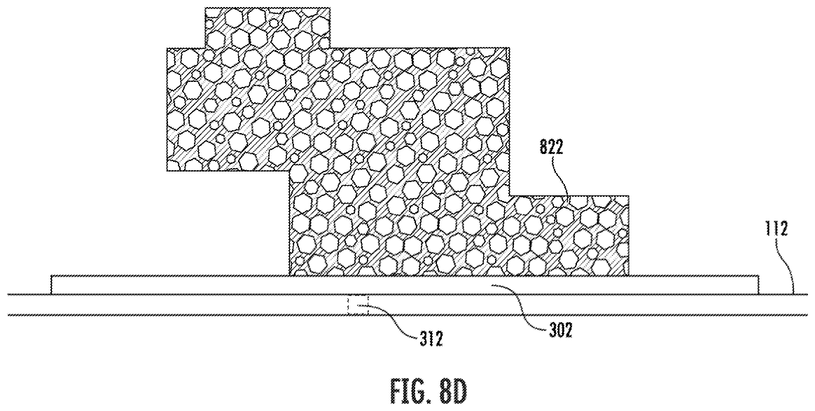

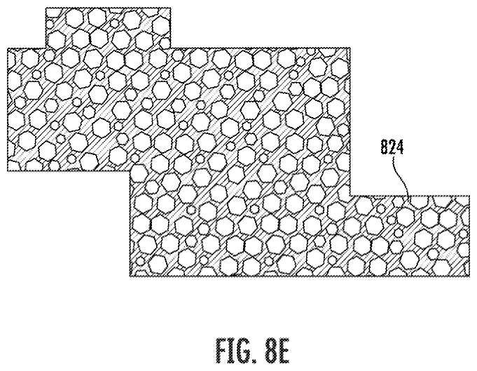

After the metal base is created (S204), metal powder is dispensed (S704). In one example embodiment as shown in FIG. 8A, dispensing controller 116 controls solution dispenser 102, via a control line 124, to dispense metal powder through piping 126 to positional tip and dispenser 800, wherein positional tip and dispenser 800 first dispenses a powder layer of metal particles 804. In other embodiments, any other known system for depositing powder layer of metal particles 804 may be employed.

In this example embodiment, dispenser 800 includes a first dispensing portion operable to dispense the metal particles as a layer of powder and a second dispensing portion operable to subsequently dispense the electroplating solution within a portion of the layer of powder. In some embodiments, the first dispensing portion and the second dispensing portion may be the same portion merely performing different actions of dispensing and different times.

After metal power is dispensed (S704), electroplating is performed (S706). FIG. 8A illustrates a side view of another positional tip and dispenser 800 in accordance with aspects of the present disclosure at a time t₅.

For example, as shown in FIG. 8A, dispensing controller 116 controls solution dispenser 102, via a control line 124, to dispense an electroplating solution through piping 126 to positional tip and dispenser 800. Dispensing controller 116 additionally controls, via a control line 128, positioning system 104 to position positional tip and dispenser 800 so as to initiate dispensing of the electroplating solution 802 into powder layer of metal particles 804 in the location in which metal is to be plated. As shown in the figure, metal 806 electroplates in an area of powder layer of metal particles 804 that includes deposited electroplating solution 802.

As shown in FIG. 1, voltage controller 118 provides a positive voltage bias to positional tip and dispenser 800 via voltage control line 130 and provides a negative voltage bias to metal base 302 (not shown in FIG. 8A) via a voltage control line 132 in a manner similar to the embodiment discussed above with reference to FIG. 3. The potential difference between the positive voltage bias provided to positional tip and dispenser 800 and the negative voltage bias provided to metal base 302 results in an electrical conduction through the area of powder layer of metal particles 804 that includes deposited electroplating solution 802, which results in the electroplating of the metal particles onto metal base 302.

As shown by the arrow 808, positional tip and dispenser 800 is moving in a direction so as to dispense the electroplating solution in a linear form.

After electroplating is performed (S706), it is determined whether electroplating is complete (S208) in a manner similar to that discussed above with reference to method 200. If electroplating is not complete (N at S208), then positional tip and dispenser 800 is moved (S210) in a manner similar to that discussed above with reference to method 200.

After the positional tip and dispenser 800 is moved (S210), more powder dispensed and method 700 continues (S704).

FIG. 8B illustrates a side view of positional tip and dispenser 800 of FIG. 8A at a time t₆, which is after time ts. In this example, positional tip and dispenser 800 has deposited another powder layer of metal particles 812 on top of the previous powder layer of metal particles 804 and previous electroplated metal of FIG. 8A. Further, positional tip and dispenser 800 has now moved in a direction shown by arrow 810 to dispense electroplating solution in a linear form.

Again, as shown in FIG. 1, voltage controller 118 provides a positive voltage bias to positional tip and dispenser 800 via voltage control line 130 and provides a negative voltage bias to metal base 302 (not shown in FIG. 8B) via a voltage control line 132 in a manner similar to the embodiment discussed above with reference to FIG. 3. The potential difference between the positive voltage bias provided to positional tip and dispenser 800 and the negative voltage bias provided to metal base 302 results in an electrical conduction through the area of powder layer of metal particles 812 that includes deposited electroplating solution 802, which results in the electroplating of the metal particles onto the previous electroplated metal. In this manner, the overall shape of the electroplate metal is able to include an overhang 814, which is much more difficult to do in the method 200 discussed above with reference to FIGS. 2-6.

FIG. 8C illustrates a side view of positional tip and dispenser 800 of FIG. 8A at a time t₇, which is after time t₆ of FIG. 8B. In this example, positional tip and dispenser 800 has deposited another powder layer of metal particles 818 on top of the previous powder layer of metal particles and previous electroplated metal of FIG. 8B. Further, positional tip and dispenser 800 has now moved in a direction shown by arrow 816 to dispense electroplating solution in a linear form.

Again, as shown in FIG. 1, voltage controller 118 provides a positive voltage bias to positional tip and dispenser 800 via voltage control line 130, and provides a negative voltage bias to metal base 302 (not shown in FIG. 8C) via a voltage control line 132 in a manner similar to the embodiment discussed above with reference to FIG. 3. A potential difference exists between the positive voltage bias provided to positional tip and dispenser 800 and the negative voltage bias provided to metal base 302. This potential difference results in an electrical conduction through the area of powder layer of metal particles 818 that includes deposited electroplating solution 802. This electrical conduction results in the electroplating of the metal particles onto the previous electroplated metal.

If electroplating is complete (Y at S208), then excess material is removed (S708). In an example embodiment, as shown in FIG. 1, removing system 108 removes the excess metal power, i.e., the metal powder that has not been electroplated. FIG. 8D illustrates a side view of a 3D electroplated metal shape 822 at a time t₈, which is after time t₇ of FIG. 8C. As shown in FIG. 8D the excess powder of metal particles is removed, thus revealing a 3D electroplated metal shape 822 on metal base 302.

After excess material is removed (S212), portions of the metal base may be removed (S214) in a manner similar to that discussed above with reference to method 200.

After portions of the metal base are removed (S214) method 200 stops (S216).

FIG. 8E illustrates a side view of a 3D object 824 at a time t₉, which is after time t₈ of FIG. 8D. Three-dimensional object 822 has been created by method 700 of FIG. 7. In this example, the entirety of metal base 302 as shown in FIG. 8D has been removed. However, in some embodiments, metal base 302 may remain as desired. As mentioned previously, system 100 and method 700 3D printed a metal object without sintering, thereby avoiding the temperatures and energy required for sintering.

In the embodiment discussed above with reference to FIGS. 2-6, the positional tip and the dispenser of the electroplating solution having the metal particles suspended therein are a unitary device. On the other hand, in the embodiment discussed above with reference to FIGS. 7-8D, the positional tip and the dispenser of the electroplating solution are a unitary device, but the dispenser of the powder may be another device.

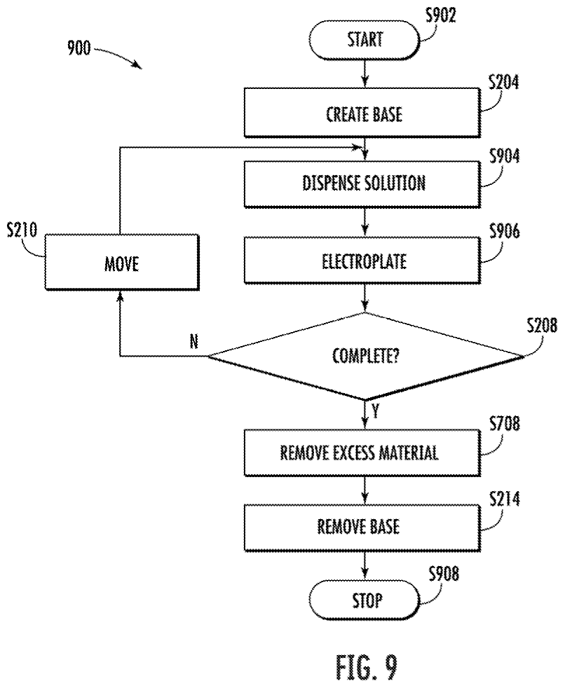

FIG. 9 illustrates another example method 900 of 3D metal printing in accordance with aspects of the present disclosure. As shown in the figure, method 900 starts (S902) and a metal base is created (S204) in a manner similar to that of method 200 discussed above.

After the metal base is created (S204), a solution with metal particles suspended therein is dispensed (S904). For example, as shown in FIG. 1, dispensing controller 116 controls solution dispenser 102, via a control line 124, to dispense metal particles suspended in an electroplating solution through piping 126 to positional tip and dispenser 120. In this example, any known dispensing apparatus or system may be used to dispense metal particles suspended in an electroplating solution 1008 onto metal base 302.

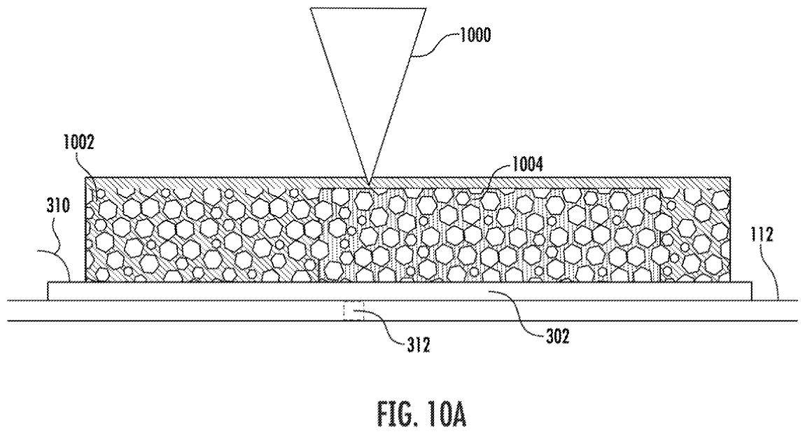

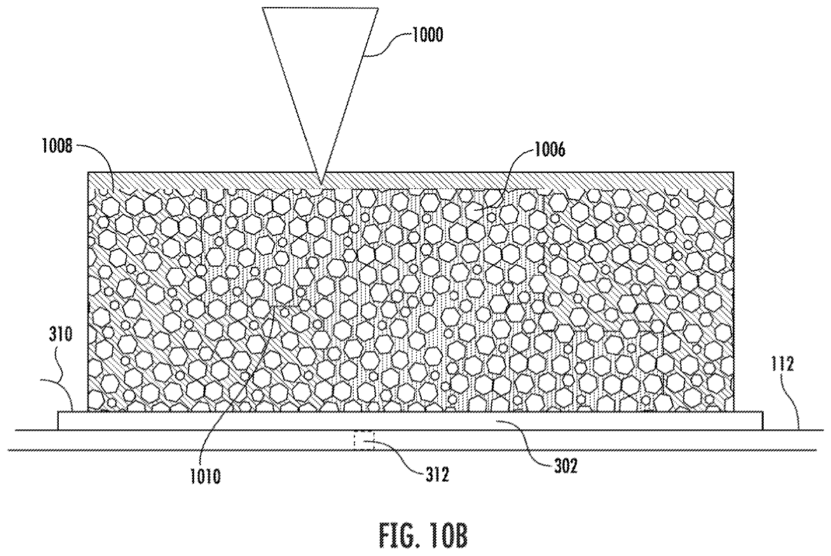

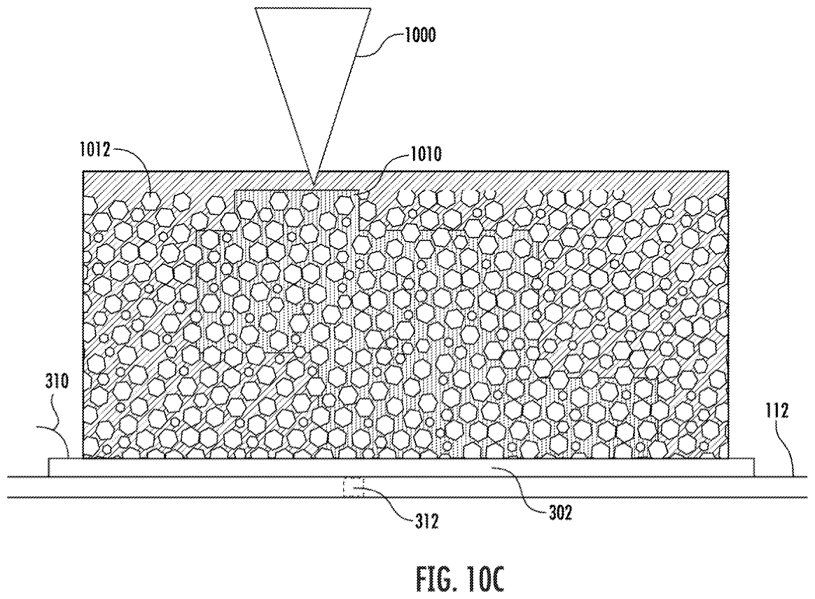

After solution is dispensed (S904), electroplating is performed (S906). As shown in FIG. 1, voltage controller 118 provides a positive voltage bias to positional tip and dispenser 120 via a voltage control line 130 and provides a negative voltage bias to metal base 302 (not shown in FIG. 1) via a voltage control line 132. In this example embodiment, voltage controller 118 provides a positive voltage bias to a positional tip, as opposed to positional tip and dispenser. This is shown in FIG. 10A.

FIG. 10A illustrates a side view of a positional tip 1000 in accordance with aspects of the present disclosure at a time t₉. As shown in the figure, the negative voltage bias is provided to metal base 302 by way of conducting wire 312, conducting via 310 or any other known mechanism. The potential difference between the positive voltage bias provided to positional tip 1000 and the negative voltage bias provided to metal base 302 results in an electrical conduction through electroplating solution 1002 that results in the electroplating of the metal particles 1004 onto metal base 302. In this example embodiment, positional tip 1000 is pointed so as to more accurately induce localized electroplating of metal particles.

After electroplating is performed (S906), it is determined whether electroplating is complete (S208) in a manner similar to that discussed above with reference to method 200. If electroplating is not complete (N at S208), then positional tip 1000 is moved (S210) in a manner similar to that discussed above with reference to method 200.

After positional tip 1000 is moved (S210), more solution is dispensed and method 900 continues (S904). FIG. 10B illustrates a side view of positional tip 1000 of FIG. 10A at a time t₁₀, which is after time t₉ of FIG. 10A. In this example, more electroplating solution having metal particles dispersed therein has been deposited on top of the previous electroplating solution having metal particles dispersed therein and previous electroplated metal of FIG. 10A. Further, positional tip 1000 has now moved to electroplate metal in a linear form.

Again, as shown in FIG. 1, voltage controller 118 provides a positive voltage bias to positional tip 1000 via voltage control line 130 and provides a negative voltage bias to metal base 302 (not shown in FIG. 10B) via a voltage control line 132 in a manner similar to the embodiment discussed above with reference to FIG. 3. The potential difference between the positive voltage bias provided to positional tip 1000 and the negative voltage bias provided to metal base 302 results in an electrical conduction through the area of deposited electroplating solution 1002, which results in the electroplating of the metal particles onto the previous electroplated metal. With a similar result as discussed with reference to method 700 and shown in FIG. 8B above, the overall shape of the electroplated metal is able to include an overhang 1010, which is much more difficult to do in the method 200 discussed above with reference to FIGS. 2-6.

FIG. 10C illustrates a side view of positional tip 1000 of FIG. 10A at a time t₁₁, which is after time t₁₀ as shown in FIG. 10B. In this example, more electroplating solution having metal particles dispersed therein has been deposited on top of the previous electroplating solution having metal particles dispersed therein and previous electroplated metal of FIG. 10B. Further, positional tip 1000 has now moved to electroplate more metal particles in a linear form.

Again, as shown in FIG. 1, voltage controller 118 provides a positive voltage bias to positional tip 1000 via voltage control line 130 and provides a negative voltage bias to metal base 302 (not shown in FIG. 10C) via a voltage control line 132 in a manner similar to the embodiment discussed above with reference to FIG. 3. The potential difference between the positive voltage bias provided to positional tip 1000 and the negative voltage bias provided to metal base 302 results in an electrical conduction through electroplating solution 1012, which results in the electroplating of the metal particles onto the previous electroplated metal.

If electroplating is complete (Y at S208), then excess material is removed (S708) in a manner similar to that discussed above with reference to method 700. The difference in this method being that, as opposed to excess powder metal being washed away, excess electroplating solution having metal particles disposed therein being washed away. After excess material is removed (S708), portions of the metal base may be removed (S214) in a manner similar to that discussed above with reference to method 200.

After portions of the metal base are removed (S214) method 200 stops (S216).

As mentioned previously, in the embodiment discussed above with reference to FIGS. 2-6, the positional tip and the dispenser of the electroplating solution having the metal particles suspended therein are a unitary device. On the other hand, in the embodiment discussed above with reference to FIGS. 9-10C, the positional tip and the dispenser of the electroplating solution having metal particles suspended therein are separate devices.

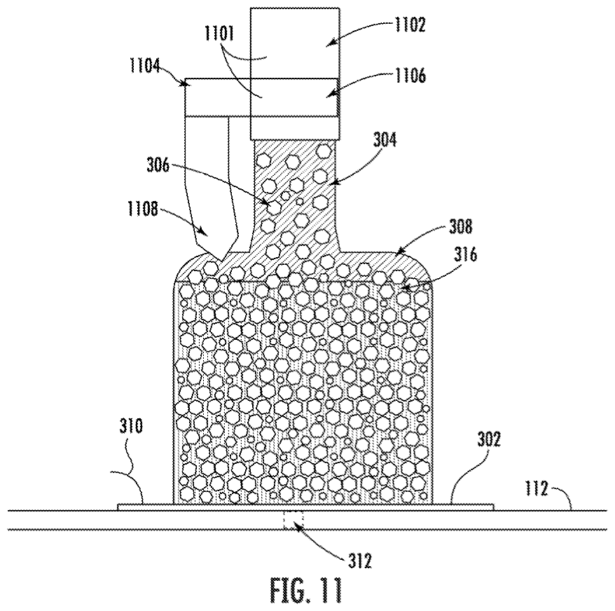

In accordance with another aspect of the present disclosure, a non-conducting positional tip and dispenser may be modified for electroplating. If using dispensing tip that is not conductive or the tip is not immersed in the electroplating solution, a conductive anode needle may be attached to the print head. The electroplating tip would act as the positive anode trailing the dispensing tip. This will be described with reference to FIG. 11.

FIG. 11 illustrates a positional tip and dispenser 1101 dispensing metal particles and an electroplating solution for 3D metal printing in accordance with aspects of the present disclosure. Positional tip and dispenser 1101 includes an insulating dispensing tip 1102 and an electroplating tip 1104. Electroplating tip 1104 includes a connecting portion 1106 and an electroplating portion 1108. Connecting portion 1106 is operable to connect to insulating dispensing tip 1102. Electroplating portion 1108 is arranged so as to contact a portion of the dispensed metal particles 206 suspended in electroplating solution 208 and is operable to receive the positive electrical bias from voltage controller 118.

In accordance with aspects of the present disclosure, metal 3D printing can be densely printed at room temperature. This would allow the 3D printing of temperature sensitive materials at the same time as the metal.

It should be noted than in some embodiments, the electroplating anode could be the 3D printing dispensing tip, or it could be an electrode further upstream. Further, in some embodiments, the electrode biases could be reversed for anodizing or anodic etching.

The foregoing description of various embodiments has been presented for purposes of illustration and description. It is not intended to be exhaustive or to limit the disclosure to the precise forms disclosed, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

What is claimed as new and desired to be protected by Letters Patent of the United States is:

1. A system for use with a volume of metal particles suspended in electroplating solution, said system comprising:
a positional tip operable to have a positive electrical bias;
a dispenser operable to dispense at least one of the metal particles and the electroplating solution;
a metal base depositing system operable to deposit a metal base;
a controller operable to control said positional tip to move and to control said dispenser to dispense the at least one of the metal particles and the electroplating solution; and
a voltage controller operable to provide the positive electrical bias to said positional tip and to provide a negative electrical bias to said metal base so as to electroplate metal onto said metal base from the metal particles suspended in the electroplating solution and so as to three-dimensionally print a metal shape.

2. The system of claim 1, wherein said positional tip and said dispenser are a unitary device.

3. The system of claim 2, wherein said controller is operable to control said positional tip to move and to control said dispenser to dispense the metal particles suspended in the electroplating solution.

4. The system of claim 1, wherein said dispenser comprises a first dispensing portion operable to dispense the metal particles as a layer of powder and a second dispensing portion operable to subsequently dispense the electroplating solution within a portion of the layer of powder.

5. The system of claim 4, wherein said positional tip and said second dispensing portion are a unitary device.

6. The system of claim 1, wherein said positional tip and said dispenser are separate components.

7. The system of claim 6, wherein said controller is operable to control said positional tip to move and to control said dispenser to dispense the metal particles suspended in the electroplating solution.

8. The system of claim 1,
wherein the positional tip comprises an insulating dispensing tip and an electroplating tip,
wherein the insulating dispensing tip is operable to dispense the metal particles suspended in electroplating solution,
wherein the electroplating tip has a connecting portion and an electroplating portion,
wherein the connecting portion is operable to connect to the insulating dispensing tip, and
wherein the electroplating portion is arranged so as to contact a portion of the dispensed metal particles suspended in electroplating solution and is operable to receive the positive electrical bias from the voltage controller.

9. A method comprising:
depositing, via a metal base depositing system, a metal base;
dispensing, via a dispenser, at least one of metal particles and an electroplating solution;
controlling, via a controller, a positional tip to move;
controlling, via the controller, the dispenser to dispense the at least one of the metal particles and the electroplating solution; and
providing, via a voltage controller, a positive electrical bias to the positional tip and a negative electrical bias to the metal base so as to electroplate metal onto the metal base from the metal particles suspended in the electroplating solution and so as to three-dimensionally print a metal shape.

10. The method of claim 9, wherein the positional tip and the dispenser are a unitary device.

11. The method of claim 10, wherein the controller is operable to control the positional tip to move and to control the dispenser to dispense the metal particles suspended in the electroplating solution.

12. The method of claim 9, wherein the dispenser comprises a first dispensing portion operable to dispense the metal particles as a layer of powder and a second dispensing portion operable to subsequently dispense the electroplating solution within a portion of the layer of powder.

13. The method of claim 12, wherein the positional tip and the second dispensing portion are a unitary device.

14. The method of claim 9, wherein the positional tip and the dispenser are separate components.

15. The method of claim 14, wherein the controller is operable to control the positional tip to move and to control the dispenser to dispense the metal particles suspended in the electroplating solution.

16. The method of claim 9,
wherein the positional tip comprises an insulating dispensing tip and an electroplating tip,
wherein the insulating dispensing tip is operable to dispense the metal particles suspended in electroplating solution,
wherein the electroplating tip has a connecting portion and an electroplating portion,
wherein the connecting portion is operable to connect to the insulating dispensing tip, and
wherein the electroplating portion is arranged so as to contact a portion of the dispensed metal particles suspended in electroplating solution and is operable to receive the positive electrical bias from the voltage controller.

17. A metal object prepared by a process which comprises:
depositing, via a metal base depositing system, a metal base;
dispensing, via a dispenser, at least one of metal particles and an electroplating solution;
controlling, via a controller, a positional tip to move;
controlling, via the controller, the dispenser to dispense the at least one of the metal particles and the electroplating solution; and
providing, via a voltage controller, the positive electrical bias to the positional tip and a negative electrical bias to the metal base so as to electroplate metal onto the metal base from the metal particles suspended in the electroplating solution and so as to three-dimensionally print a metal shape.

18. The metal object of claim 17, wherein the positional tip and the dispenser are a unitary device.

19. The metal object of claim 17, wherein the dispenser comprises a first dispensing portion operable to dispense the metal particles as a layer of powder and a second dispensing portion operable to subsequently dispense the electroplating solution within a portion of the layer of powder.

20. The metal object of claim 17, wherein the positional tip and the dispenser are separate components.
